(19) United States
(12) Patent Application Publication
(10) Pub. No.: US 2025/0011146 A1
(43) Pub. Date: Jan. 9, 2025

(54) CONSTRUCTION MACHINE

(71) Applicant: Robert Bosch GmbH, Stuttgart (DE)

(72) Inventors: Rafael Cardoso, Fountain Inn, SC (US); Xiaofan Guo, Fountain Inn, SC (US); Frank C. Karsten, Wooster, OH (US); Enrique Busquets, Greer, SC (US)

(21) Appl. No.: 18/346,598

(22) Filed: Jul. 3, 2023

(51) Int. Cl. B66F 11/04

(52) U.S. Cl. CPC B66F 11/046

(57) ABSTRACT

A construction machine including a pump, a pressure sensor measuring a pressure, and a work cylinder including a rod operable to extend and retract. The work cylinder has a bore chamber, a rod chamber, a bore chamber pressure sensor, a bore pressure, a rod chamber pressure sensor, and a rod pressure. The machine includes an input moveable between neutral, extension, and retraction positions, and a sensor to measure the position. The machine includes a controller programmed with an algorithm to control movement of the work cylinder on the basis of the detected position of the operator input. The algorithm is configured to confirm that the pump pressure exceeds the bore side chamber pressure as a prerequisite to setting a command that controls movement of the work cylinder for rod extension, in response to identification of the operator input in the rod extension position.

### BACKGROUND

The present disclosure relates to hydraulic systems for construction machines.

### SUMMARY

The present disclosure provides, in one aspect, a construction machine including a pump, a pressure sensor, a work cylinder, a bore side chamber pressure sensor, an operator input, and a controller. The pressure sensor is configured to measure a pump pressure. The work cylinder includes a rod operable to extend and retract. A bore side chamber of the work cylinder is configured to be supplied with fluid from the pump during rod extension while fluid is removed from a rod side chamber. The rod side chamber of the work cylinder is configured to be supplied with fluid from the pump during rod retraction while fluid is removed from the bore side chamber. The bore side chamber pressure sensor is configured to measure a bore side chamber pressure. The operator input is moveable between a neutral position, a rod extension position, and a rod retraction position. The operator input includes a position sensor configured to measure the neutral position, the rod extension position, and the rod retraction position. The controller is communicatively coupled to the work cylinder and is programmed with an algorithm configured to control movement of the work cylinder on the basis of the detected position of the operator input. The algorithm is configured to confirm that the pump pressure exceeds the bore side chamber pressure as a prerequisite to setting a command that controls movement of the work cylinder for rod extension, in response to identification of the operator input in the rod extension position.

The present disclosure relates, in another aspect, to a construction machine including a pump, a pressure sensor, a work cylinder, a bore side chamber pressure sensor, an operator input, a master spool, a pilot control valve, and a controller. The pressure sensor is configured to measure a pump pressure. The work cylinder includes a rod operable to extend and retract. A bore side chamber of the work cylinder is configured to be supplied with fluid from the pump during rod extension while fluid is removed from a rod side chamber. The rod side chamber of the work cylinder is configured to be supplied with fluid from the pump during rod retraction while fluid is removed from the bore side chamber. The bore side chamber pressure sensor is configured to measure a bore side chamber pressure. The operator input is moveable between a neutral position, a rod extension position, and a rod retraction position. The operator input includes a position sensor configured to measure the neutral position, the rod extension position, and the rod retraction position. The master spool is in fluid communication with the work cylinder and the pump. The pilot control valve is in fluid communication with the master spool and the pump. The controller is communicatively coupled to the work cylinder and programmed with an algorithm configured to output a signal to the pilot control valve to control an output thereof on the basis of the detected position of the operator input. The algorithm is configured to confirm that the pump pressure exceeds the bore side chamber pressure as a prerequisite to setting a command that controls movement of the pilot control valve for rod extension, in response to identification of the operator input in the rod extension position

The present disclosure further relates to a method of controlling a construction machine. The method includes a controller receiving a position signal from a position sensor measuring a neutral position, a rod extension position, and a rod retraction position of an operator input. The controller receives a pump pressure of a pump from a pressure sensor. The controller receives a bore pressure from a bore pressure sensor on a bore side of a work cylinder, the bore side of the work cylinder increasing in volume during a rod extension and decreasing in volume during a rod retraction. The controller receives a rod pressure from a rod pressure sensor on a rod side of the work cylinder, the rod side of the work cylinder decreasing in volume during the rod extension and increasing in volume during the rod retraction. The controller analyzes the position signal, the pump pressure, the bore pressure, and the rod pressure. The controller confirms that the pump pressure exceeds the bore pressure as a prerequisite to setting a command that controls movement of the work cylinder for rod extension, in response to identification of the operator input in the rod extension position.

### BRIEF DESCRIPTION OF THE DRAWINGS

FIG. 1 illustrates a schematic representation of a hydraulic system and an associated boom cylinder of a construction machine.

FIG. 2 illustrates a flowchart detailing a control algorithm for the hydraulic system.

FIG. 3 illustrates an exemplary construction machine.

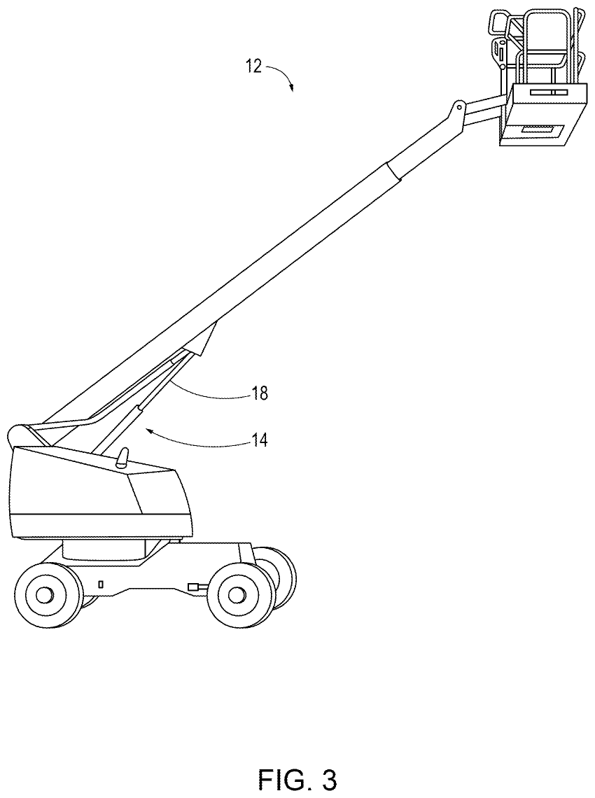

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

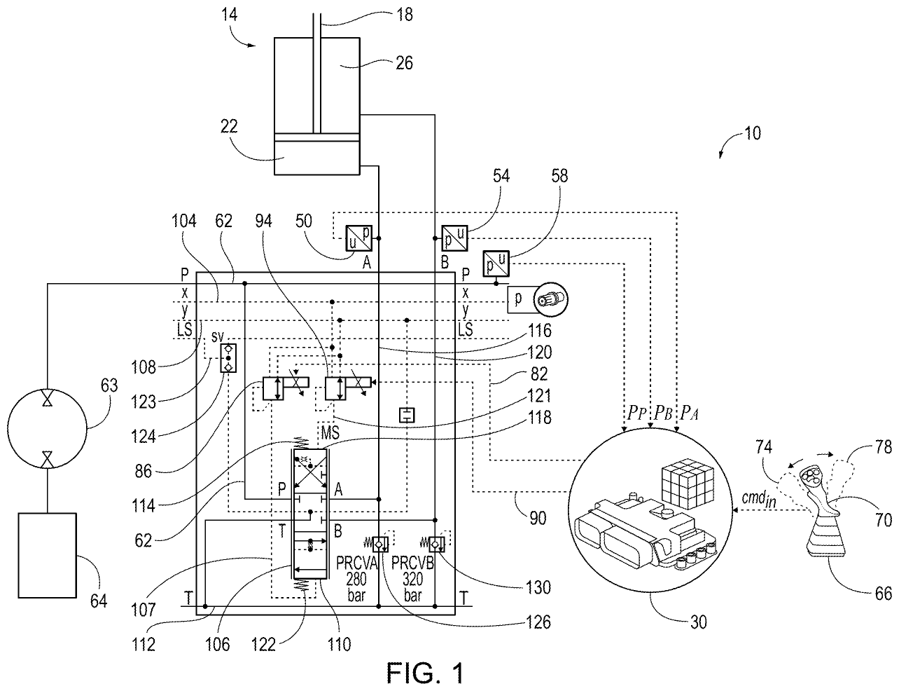

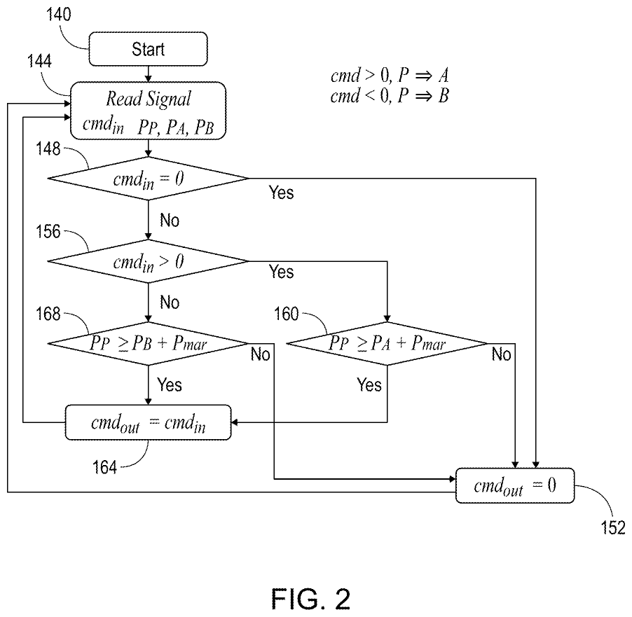

FIG. 1 is a schematic illustration of a hydraulic system 10 for use in a construction machine 12 with a boom cylinder 14. The hydraulic system 10 may also be used with other work cylinders such as a bucket cylinder and an arm cylinder. The boom cylinder 14 includes a rod 18 that is operable to extend and retract a boom of the construction machine 12. Examples of contraction machines include skid steer loaders, compact wheel loader, mini excavators, and dump trucks. The boom cylinder 14 includes a bore side chamber 22 and a rod side chamber 26. The bore side chamber 22 is located in the boom cylinder 14 such that the rod 18 extends outwardly as the fluid volume in the bore side chamber 22 increases and the fluid volume in the rod side chamber 26 decreases. The rod side chamber 26 is located in the boom cylinder 14, about the rod 18, such that the rod 18 retracts into the boom cylinder 14 as the fluid volume in the rod side chamber 26 increases and the fluid volume in the bore side chamber 22 decreases. The fluid supplied to the bore side chamber 22 and the rod side chamber 26 is supplied by a main control valve 106 (e.g., a master spool) which is controlled by a controller 30. The controller 30 includes a control system 100 for a load holding function the load while extending and retracting the rod 18 of the boom cylinder 14 (FIG. 2). In contrast, solutions for holding the load during extension and retraction of the rod 18 utilize additional valves. U.S. Pat. No. 10,590,962 describes the use of a pressure compensator valve and a counterbalance valve for load holding. U.S. Pat. No. 5,579,642 describes the use of a post-compensated control valve for load holding. The hydraulic system 10 is capable of load holding without the use of additional valves by integrating the control system 100. The control system 100 will be discussed in more detail below.

The controller 30 may include one or more electronic processors and one or more memory devices. The controller 30 may be communicably connected to one or more sensors or other inputs, such as described herein. The electronic processor may be implemented as a programmable microprocessor, an application specific integrated circuit (ASIC), one or more field programmable gate arrays (FPGA), a group of processing components, or with other suitable electronic processing components. The memory device (for example, a non-transitory, computer-readable medium) includes one or more devices (for example, RAM, ROM, flash memory, hard disk storage, etc.) for storing data and/or computer code for completing the or facilitating the various processes, methods, layers, and/or modules described herein. The memory device may include database components, object code components, script components, or other types of code and information for supporting the various activities and information structure described in the present application. According to one example, the memory device is communicably connected to the electronic processor and may include computer code for executing one or more processes described herein. The controller 30 may further include an input-output (“I/O”) module. The I/O module may be configured to interface directly interface with one or more devices, such as a power supply, sensors, displays, etc. In one embodiment, the I/O module may utilize general purpose I/O (GPIO) ports, analog inputs/outputs, digital inputs/outputs, and the like. As detailed further below, the controller 30 can be programmed with an algorithm.

The algorithm of the controller 30 is configured to interpret and analyze a plurality of signals. The plurality of signals includes a bore side pressure P_{A}, a rod side pressure PB, a pump pressure P_{P}, and a position signal cmdᵢₙ. The bore side pressure P_{A} is measured by a bore side pressure sensor 50 and the rod side pressure PB is measured by a rod side pressure sensor 54. The pump pressure P_{P} is measured by a pressure sensor 58. The bore side pressure sensor 50, the rod side pressure sensor 54, and the pressure sensor 58 are pressure transducers. The pressure sensor 58 is in communication with a pump line 62 (e.g., schematically illustrated with P) which is communication with a pump 63. The position signal cmdᵢₙ is measured by a position sensor 66 and is dependent upon the actuation of an operator input 70 (i.e., joystick) to a neutral position (shown in FIG. 1), a rod extension position 74, and rod retraction position 78. The controller 30 is in data communication with each of the sensors 50, 54, 58, 66 such that the parameters measured thereby can be periodically or continuously provided to the controller 30. The algorithm of the controller 30 analyzes the bore side pressure P_{A}, the rod side pressure PB, the pump pressure P_{P}, and the position signal cmdᵢₙ and determines whether to send a signal 82 to a first pilot control valve 86 (in response to the rod extension position 74 of the operator input 70), or whether to send a signal 90 to a second pilot control valve 94 (in response to the rod retraction position 78 of the operator input 70). Depending on the monitored conditions, the algorithm may instead disregard or ignore the rod extension or rod retraction command from the operator input 70, and default to load holding. More details of a control system 100 of the algorithm of the controller 30 are discussed below (FIG. 2).

The pump 63 is a variable displacement pump (e.g., axial piston pump) capable of varying the displacement setting (e.g., via swash plate angle) and is driven by a drive source 64. The drive source 64 may include an internal combustion engine or an electric motor to drive the pump 63. Furthermore, the pump 63 is variable for positive and negative displacement (i.e., reversible flow direction from a flow-producing “Pumping” mode to a flow-receiving “Motoring” mode) and is referred to as having over-center capability as it can switch between positive and negative during operation. The pump 63 may also be referred to as an over-center variable displacement pump. In some constructions, the pump 63 can be a Bosch Rexroth A10VO with eOC control (also called EC4), although other pumps may also be suitable for use. The pump 63 is fluidly connected to the pump line 62 and provides the pump pressure P_{P}. The pump 63 is electronically controlled such that the pump 63 may receive load values by receiving the bore side pressure P_{A}, the rod side pressure PB, and the pump pressure P_{P}. The pilot control valves 86, 94 are both capable of individually actuating to an activated state from an inactive state in response to the signals 82, 90. In the activated state, the pilot control valves 86, 94 receive the signals 82, 90, respectively, to allow fluid communication between a control pressure line 104 (e.g., schematically illustrated with x) and the master spool 106. The control pressure line 104 is maintained at a pressure between 25-30 bar by the pump 63 and causes the master spool 106 to actuate. In other constructions, the control pressure line 104 is maintained at a pressure between 25-30 bar by a charge pump.

The pilot control valve 86 in the activated state is used for the rod extension and permits fluid communication of pressurized fluid from the control pressure line 104 into a line 107 towards a first end 110 of the master spool 106. The pressurized fluid supplied by the line 107 actuates the master spool 106 against a bias force provided by a spring 114 and actuates the master spool 106 into a rod extension position. The rod extension position of the master spool 106 permits fluid communication between a first work port A, which is in fluid communication with the bore side chamber 22 via bore line 116, and the pump line 62. The pump line 62 supplies pressurized fluid to the bore line 116, and therefore the bore side chamber 22, to increase the fluid volume within the bore side chamber 22 to extend the rod 18. The rod extension position of the master spool 106 permits fluid communication between a second work port B, which is in fluid communication with the rod side chamber 26 via line 120, and a tank line 112. The tank line 112 is connected to a tank (e.g., schematically illustrated with T) at atmospheric pressure. Fluid is sent from the rod side chamber 26 to the tank line 112 during rod extension. Since the first pilot control valve 86 is in the active state, the second pilot control valve 94 must be in the inactive state to permit actuation of the master spool 106 to the rod extension position. The second pilot control valve 94 enables fluid communication between a line 108 (e.g., schematically illustrated with y), which is in fluid communication with the tank line 112, and a second end 118 of the master spool 106 via line 121. This allows fluid at the second end 118 of the master spool 106 to disperse as the master spool 106 move towards the rod extension position.

The second pilot control valve 94 in the active state is used for the rod retraction and operates similarly to the first pilot control valve 86 in its active state. Instead of the pressurized fluid from the control pressure line 104 being sent to the first end 110 of the master spool 106, the pressurized fluid is sent by the second pilot control valve 94 to the second end 118 of the master spool 106 via the line 121 to actuate the master spool 106 against a bias of a spring 122 into a rod retraction position. The rod retraction position of the master spool 106 permits fluid communication between the second work port B and the pump line 62. The pump line 62 supplies pressurized fluid to the rod side chamber 26 via the line 120 to increase the fluid volume within the rod side chamber 26 to retract the rod 18. The rod retraction position of the master spool 106 permits fluid communication between the first work port A and the tank line 112 via the bore line 116. The bore side chamber 22 will send fluid to the tank line 112 during an increase in fluid volume within the rod side chamber 26 to permit rod extension of the rod 18. Since the pilot control valve 94 is in the active state, the pilot control valve 86 must be in the inactive state to permit actuation of the master spool 106 to the rod retraction position. The pilot control valve 86 permits fluid communication between the line 108 and the first end 110 of the master spool 106 via the line 107. This allows fluid at the first end 110 of the master spool 106 to disperse as the master spool 106 moves towards the rod retraction position.

In addition to the two states discussed above, both the pilot control valves 86, 94 may simultaneously be in inactive states when the rod 18 is neither extending nor retracting. In the inactive state, both the pilot control valves 86, 94 supply the master spool 106 fluid at atmospheric pressure from the line 108. Due to the absence of pressure, the master spool 106 is biased by the springs 114, 122 into a neutral state in which the first work port A and the second work port B are both blocked with the master spool 106 from fluid communication with the pump line 62 and the tank line 112.

The hydraulic system 10 further comprises a load sensing line 123 (e.g., schematically illustrated with LS), a shuttle valve 124, a bore side pressure relief valve 126, and a rod side pressure relief valve 130. The load sensing line 123 and the shuttle valve 124 are provided in instances where the pump 63 is a hydromechanical load sensing pump. The load sensing line 123 is selectively in fluid communication with the line 108 via the shuttle valve 124. In a hydraulic system with a hydromechanical load sensing pump, a control device keeps the pump pressure of the hydromechanical load sensing pump equal to the sum of the load sensing line pressure and a pressure margin. In contrast, the pump 63 electronically controls the pump pressure P_{P} based on pressure readings of the bore side pressure P_{A}, the rod side pressure PB, and the pump pressure P_{P}. The bore side pressure relief valve 126 is disposed between the bore line 116 and the tank line 112. The bore side pressure relief valve 126 enables fluid communication between the bore side chamber 22 and the tank line 112 via line 116 if a bore side pressure P_{A} exceeds a pressure threshold. The pressure threshold for the bore side chamber is approximately 280 bar. In other constructions, the pressure threshold may be less than or greater than 280 bar. The rod side pressure relief valve 130 enables fluid communication between the rod side chamber 26 and the tank line 112 via line 120 if a rod side pressure PB exceeds a pressure threshold of 320 bar. In other constructions, the pressure threshold may be less than or greater than 320 bar for the pressure relief valves 126 and 130.

FIG. 2 illustrates logic of the control system 100 used to control the fluid volume within the bore side chamber 22 and the rod side chamber 26, and thus movement of the rod 18. The control system 100 begins at block 140 when the construction machine 12 is turned on. At block 144, the algorithm of the controller 30 receives the input signal cmdᵢₙ from the position sensor 66, the pump pressure P_{P}, the bore side pressure P_{A}, and the rod side pressure PB. At block 148, the algorithm identifies whether the position of the operator input 70 is in the neutral position (FIG. 1). The algorithm continues to block 152 during detection of the neutral position and the algorithm executes the holding function by setting the controller output cmdₒᵤₜ equal to the input signal cmdᵢₙ (and cmdₒᵤₜ=cmdᵢₙ=0). In other words, neither pilot control valve 86, 94 is activated, and the master spool 106 remains in the neutral position. The algorithm restarts at the block 144 and the master spool 106 is retained in the neutral position (i.e., the pilot control valves 86 and 94 do not receive a signal to an active state) during the hold function. As described previously, the algorithm moves from block 144 to block 148 to identify whether the operator input 70 is in the neutral position (FIG. 1).

The algorithm moves to block 156 from block 148 in the condition that the operator input 70 is not in the neutral position (FIG. 1). The algorithm identifies whether the position of the operator input 70 is in the rod extension position 74 (i.e., cmdᵢₙ>0). The algorithm moves to block 160 in the condition that the operator input 70 is in the rod extension position 74. At block 160, the algorithm checks whether the pump pressure P_{P} is greater than or equal to a sum of the bore side pressure P_{A} and a prescribed margin Pₘₐᵣ (i.e., P_{P}≥ P_{A}+Pₘₐᵣ). This can be generalized as the algorithm confirming that the pump pressure P_{P} exceeds the bore side pressure P_{A} (as the prescribed margin Pₘₐᵣ may be any positive value). In some envisioned constructions, the prescribed margin Pₘₐᵣ may be in the range of 20-30 bar. In other constructions, the prescribed margin Pₘₐᵣ is less than or greater than 20-30 bar. The prescribed margin Pₘₐᵣ is used to accommodate for pressure losses across the master spool 106, the lines, and other components of the hydraulic system 10. Thus, it is entirely dependent on the construction of the machine, and is likely to vary from one machine to another. The decision at block 160 acts as a prerequisite to the controller 30 setting the output cmdₒᵤₜ equal to the input cmdᵢₙ at block 164. In the illustrated construction, this results in actuation of the first pilot control valve 86 (signal 82, FIG. 1) to shift the master spool 106 and effect rod extension because the operator input 70 is in the rod extension position 74. The prescribed margin Pₘₐᵣ is incorporated into the algorithm to ensure that no back flow toward the pump 63 occurs in the pump line 62 when the master spool 106 shifts to command rod extension. As described above, load holding has previously been achieved by utilizing additional valves to ensure the pump pressure P_{P} is at the desired pressure before rod extension. The hydraulic system 10 in addition to the control system 100 achieves load holding by monitoring the position signal cmdᵢₙ, the pump pressure P_{P}, the bore side pressure P_{A}, and the rod side pressure PB and controlling the movement of the master spool 106 for rod extension. The algorithm proceeds from block 160 to block 152 in the condition that the pump pressure P_{P} is less than the sum of the bore side pressure P_{A} and the prescribed margin Pₘₐᵣ (i.e., the pump pressure P_{P} does not exceed the bore side pressure P_{A}) and continues to block 144 as described earlier. The algorithm may trigger an alert to inform the user that the pump pressure P_{P} is less than the sum of the bore side pressure P_{A} and the prescribed margin Pₘₐᵣ when moving from block 160 to block 152, as the operator will be expecting rod extension. The alert may be an audio, visual, or physical (i.e., vibration) warning to inform the user of the load holding function. The algorithm continually monitors whether the pump pressure P_{P} is greater than or equal to the sum of the bore side pressure P_{A} and the prescribed margin Pₘₐᵣ.

The algorithm moves to block 168 from block 156 in the condition that the operator input 70 is not in the rod extension position 74 (i.e., cmdᵢₙ>0 is not met, or in other words cmdᵢₙ<0 and the operator input 70 is in the rod retraction position 78). At block 168, the algorithm identifies whether the pump pressure P_{P} is greater than or equal to a sum of the rod side pressure PB and the prescribed margin Pₘₐᵣ (i.e., P_{P}≥ PB+Pₘₐᵣ). This can be generalized as the algorithm confirming that the pump pressure P_{P} exceeds the rod side pressure PB. The decision at block 168 acts as a prerequisite to the controller 30 setting the output cmdou equal to the input cmdᵢₙ at block 164. In the illustrated construction, this results in actuation of the second pilot control valve 94 (signal 90, FIG. 1) to shift the master spool 106 and effect rod retraction because the operator input 70 is in the rod retraction position 78. The prescribed margin Pₘₐᵣ is incorporated into the algorithm to ensure that no back flow toward the pump 63 occurs in the pump line 62 when the master spool 106 shifts to command rod retraction. As described above, load holding has previously been achieved by utilizing additional valves to ensure the pump pressure P_{P} is at the desired pressure before rod retraction. The algorithm proceeds to block 152 in the condition that the pump pressure P_{P} is less than the sum of the rod side pressure PB and the prescribed margin Pₘₐᵣ and continues to block 144 as described earlier. The algorithm may trigger an alert to inform the user that the pump pressure P_{P} is less than the sum of the rod side pressure PB and the prescribed margin Pₘₐᵣ when moving from block 168 towards block 152, as the operator will be expecting rod extension. The algorithm continually monitors whether the pump pressure P_{P} is greater than the rod side pressure PB in addition to the prescribed margin Pₘₐᵣ.

Although the invention has been described in detail with reference to certain preferred embodiments, variations and modifications exist within the scope and spirit of one or more independent aspects of the invention as described.

What is claimed is:

1. A construction machine comprising:
a pump;
a pressure sensor configured to measure a pump pressure;
a work cylinder including a rod operable to extend and retract, wherein a bore side chamber of the work cylinder is configured to be supplied with fluid from the pump during rod extension while fluid is removed from a rod side chamber, wherein the rod side chamber of the work cylinder is configured to be supplied with fluid from the pump during rod retraction while fluid is removed from the bore side chamber;
a bore side chamber pressure sensor configured to measure a bore side chamber pressure;
an operator input moveable between a neutral position, a rod extension position, and a rod retraction position, the operator input including a position sensor configured to detect the neutral position, the rod extension position, and the rod retraction position; and
a controller communicatively coupled to the work cylinder and programmed with an algorithm configured to control movement of the work cylinder on the basis of the detected position of the operator input,
wherein the algorithm is configured to confirm that the pump pressure exceeds the bore side chamber pressure as a prerequisite to setting a command that controls movement of the work cylinder for rod extension, in response to identification of the operator input in the rod extension position.

2. The construction machine of claim 1, further comprising a rod side chamber pressure sensor configured to measure a rod side chamber pressure, wherein the algorithm is configured to confirm that the pump pressure exceeds the rod side chamber pressure as a prerequisite to setting a command that controls movement of the work cylinder for rod retraction, in response to identification of the operator input in the rod retraction position.

3. The construction machine of claim 2, wherein the algorithm is configured to confirm that the pump pressure exceeds the rod side chamber pressure by at least a prescribed margin as a prerequisite to setting the command that controls movement of the work cylinder for rod retraction, in response to identification of the operator input in the rod retraction position

4. The construction machine of claim 2, wherein the algorithm is configured to identify that the pump pressure does not exceed the rod side chamber pressure and respond by enacting a load holding function instead of setting the command that controls movement of the work cylinder for rod retraction, in response to identification of the operator input in the rod retraction position.

5. The construction machine of claim 1, wherein the algorithm is configured to confirm that the pump pressure exceeds the bore side chamber pressure by at least a prescribed margin as a prerequisite to setting the command that controls movement of the work cylinder for rod extension, in response to identification of the operator input in the rod extension position.

6. The construction machine of claim 1, wherein the algorithm is configured to identify that the pump pressure does not exceed the bore side chamber pressure and respond by enacting a load holding function instead of setting the command that controls movement of the work cylinder for rod extension, in response to identification of the operator input in the rod extension position.

7. The construction machine of claim 1, further comprising:
a master spool connected via a fluid line with the work cylinder and the pump; and
a pilot control valve in fluid communication with the master spool and the pump, the pilot control valve configured to direct fluid to the master spool, which in turn, sends fluid from the pump to the work cylinder,
wherein the algorithm is configured to output a signal to the pilot control valve in response to the operator input in the rod extension position.

8. The construction machine of claim 7, further comprising:
a second pilot control valve in fluid communication with the master spool and the pump, the second pilot control valve configured to direct fluid to the master spool, which in turn, sends fluid from the pump to the work cylinder,
wherein the algorithm is configured to output a signal to the second pilot control valve in response to the operator input in the rod retraction position.

9. The construction machine of claim 7, wherein the pump and the master spool are directly connected, without any intermediary hydraulic components by a pump line.

10. A construction machine comprising:
a pump,
a pressure sensor configured to measure a pump pressure;
a work cylinder including a rod operable to extend and retract, wherein a bore side chamber of the work cylinder is configured to be supplied with fluid from the pump during rod extension while fluid is removed from a rod side chamber, wherein the rod side chamber of the work cylinder is configured to be supplied with fluid from the pump during rod retraction while fluid is removed from the bore side chamber,
a bore side chamber pressure sensor configured to measure a bore side chamber pressure,
an operator input moveable between a neutral position, a rod extension position, and a rod retraction position, the operator input including a position sensor configured to measure the neutral position, the rod extension position, and the rod retraction position;
a master spool in fluid communication with the work cylinder and the pump;
a pilot control valve in fluid communication with the master spool and the pump; and
a controller communicatively coupled to the work cylinder and programmed with an algorithm configured to output a signal to the pilot control valve to control an output thereof on the basis of the detected position of the operator input,
wherein the algorithm is configured to confirm that the pump pressure exceeds the bore side chamber pressure as a prerequisite to setting a command that controls movement of the pilot control valve for rod extension, in response to identification of the operator input in the rod extension position.

11. The construction machine of claim 10, wherein the pump and the master spool are directly connected, without any intermediary hydraulic components by a pump line.

12. The construction machine of claim 11, wherein the master spool is configured to enable fluid communication between the bore side chamber and the pump, in response to the pilot control valve receiving the signal.

13. The construction machine of claim 11, further comprising:
a rod side chamber pressure sensor configured to measure a rod side chamber pressure;
and a second pilot control valve, wherein the algorithm is configured to confirm that the pump pressure exceeds the rod side chamber pressure as a prerequisite to setting a command that controls movement of the second pilot control valve for rod retraction, in response to identification of the operator input in the rod retraction position.

14. The construction machine of claim 13, wherein the master spool is configured to enable fluid communication between the rod side chamber and the pump, in response to the second pilot control valve receiving the signal.

15. A method of controlling a construction machine, the method comprising:
receiving, with a controller, a position signal from a position sensor measuring a neutral position, a rod extension position, and a rod retraction position of an operator input;
receiving, with the controller, a pump pressure of a pump from a pressure sensor;
receiving, with the controller, a bore pressure from a bore pressure sensor on a bore side of a work cylinder, the bore side of the work cylinder increasing in volume during a rod extension and decreasing in volume during a rod retraction;
receiving, with the controller, a rod pressure from a rod pressure sensor on a rod side of the work cylinder, the rod side of the work cylinder decreasing in volume during the rod extension and increasing in volume during the rod retraction;
analyzing, with the controller, the position signal, the pump pressure, the bore pressure, and the rod pressure; and
confirming, with the controller in response to identification of the operator input in the rod extension position, that the pump pressure exceeds the bore pressure as a prerequisite to setting a command that controls movement of the work cylinder for rod extension.

16. The method of claim 15, further comprising identifying, with the controller in response to identification of the operator input in the rod extension position, that the pump pressure does not exceed the bore pressure, and the controller responding by enacting a load holding function instead of setting a command that controls movement of the work cylinder for rod extension.

17. The method of claim 15, further comprising confirming, with the controller in response to identification of the operator input in the rod retraction position, that the pump pressure exceeds the rod pressure as a prerequisite to setting a command that controls movement of the work cylinder for rod retraction.

18. The method of claim 17, further comprising identifying, with the controller in response to identification of the operator input in the rod retraction position, that the pump pressure does not exceed the rod pressure, and the controller responding by enacting a load holding function instead of setting a command that controls movement of the work cylinder for rod retraction.
